(19) United States
(12) Patent Application Publication
(10) Pub. No.: US 2018/0367641 A1
(43) Pub. Date: Dec. 20, 2018

(54) SATELLITE LOOP INTERACTIVE DATA EXPLORER IN REAL-TIME

(71) Applicant: Colorado State University Research Foundation, Fort Collins, CO (US)

(72) Inventor: Kevin Paul Micke, Centennial, CO (US)

(73) Assignee: Colorado State University Research Foundation, Fort Collins, CO (US)

(21) Appl. No.: 15/791,768

(22) Filed: Oct. 24, 2017

Related U.S. Application Data
(63) Continuation of application No. PCT/US2017/037980, filed on Jun. 16, 2017.

(51) Int. Cl. H04L 29/08; G06T 13/80

(52) U.S. Cl. CPC H04L 67/322; G06T 2200/32; H04L 67/06; G06T 13/80

(57) ABSTRACT

Aspects of the present disclosure involve systems, methods, and computer program products for obtaining and displaying a large image file over a network. In one embodiment, a user utilizes a computing device to obtain a large image file over a network, such as the Internet. The large image file may be stored in and available from a network device, such as an application server or database. To obtain the image file, a user interface executed on the user's computing device determines which portions of the overall image file are to be displayed in the interface. The interface may utilize one or more image variables to create or generate one or more network addresses at which the image tiles are stored or otherwise available. To retrieve the image tiles, the computing device uses the generated network addresses of the identified image tiles to request and obtain the image tiles.

### CROSS REFERENCE TO RELATED APPLICATION

The present application is a continuation of International Application PCT/US2017/037980, entitled “Satellite Loop Interactive Data Explorer in Real-Time,” with an international filing date of Jun. 16, 2017, the entirety of which is incorporated by reference herein.

### GOVERNMENT SUPPORT CLAUSE

This invention was made with government support under grant NA140AR4320125 awarded by US National Oceanic and Atmospheric Administration and grant N00173-16-1-G903 awarded by Naval Research Laboratory. The government has certain rights in the invention.

### TECHNICAL FIELD

Aspects of the present disclosure generally relate to image processing, and more particularly, to systems and methods for providing a user interface for manipulating and viewing a large image file over a network connection.

### BACKGROUND

The display and manipulation of very large image files over a network is beset with delays and inefficiencies that make it difficult for viewers to enjoy a positive experience when obtaining such images. For example, large image files (image files that are potentially made up from many millions of pixels of information) may require several gigabytes of data to display all the pixels of the image. To obtain and display such images on a user's computer device, the computer device will request the image file from a database available over a network. In a first example, the entire image is provided to the computer device prior to being displayed. While this approach operates successfully for small image files, it may take several minutes for very large image files to be downloaded before the image is displayed. Such a delay may be frustrating to some users. In another example, a small portion of the data of the entire image file is provided to the computing device and displayed on the computing device. This small portion provides a generalized version of the image file, but at a lower resolution than the full image. However, if the user desires to view a higher resolution version of a portion of the image, a user's device must first request a location in the network at which the additional data may be obtained. Upon receiving the location information, the additional data from the image file must then be requested and received from the database over the network before the portion can be displayed, providing an additional delay. This additional delay may also be frustrating to some users. As such, obtaining and viewing very large image files over a network is currently an inefficient process.

It is with these observations in mind, among others, that various aspects of the present disclosure were conceived and developed.

### SUMMARY

One implementation of the present disclosure may take the form of a computer system for operating a network. In one embodiment, the computer system may include a network device storing a plurality of image data files in communication with a communications network, the plurality of image data files corresponding to a particular source of related image files that form at least one image and a computing device in communication with the network device over the communications network. The computing device may include a processing device and a computer-readable medium connected to the processing device configured to store instructions. When the processing device executes the instructions, the computer device may receive a selection of the particular source of related image files from an input of an input device of the computing device, identify a subset of the plurality of image data files corresponding to the particular source of related image files, the subset of the plurality of image data files corresponding to a portion of the at least one image, and generate a network address for each of the subset of the plurality of image data files, wherein each of the network addresses for the subset of the plurality of image data files comprises a plurality of identification variables unique to a corresponding image data file of the plurality of image data files. The computer device may also transmit each of the network addresses for the subset of the plurality of image data files to the network device to request the subset of the plurality of image data files, receive the subset of the plurality of image data files, and process the subset of the plurality of image data files to display the at least one image on a display device of the computing device.

Another implementation of the present disclosure may take the form of a method for providing a file from a network device. The method includes the operations of storing a plurality of image data files in a storage media associated with the network device comprising a portion of a communications network, the plurality of image data files corresponding to a particular source of related image files that form at least one image and each of the plurality of image data files associated with a plurality of identification variables unique to a corresponding image data file of the plurality of image data files, receiving, from a computer device in communication with the communications network, a request for a subset of the plurality of image data files from the computer device utilizing a plurality of network addresses, each of the network addresses for the subset of the plurality of image data files comprising the plurality of identification variables unique to the corresponding image data file of the subset of the plurality of image data files, wherein each of the subset of the plurality of image data files corresponds to a portion of the at least one image, and providing the subset of the plurality of image data files to the computer device through the communications network for display on a display device associated with the computer device based at least on the received request for the subset of the plurality of image data files from the computer device.

### BRIEF DESCRIPTION OF THE DRAWINGS

FIG. 1 is a schematic diagram illustrating a system for providing a user interface for viewing and manipulating a large image file.

FIG. 2 is a schematic diagram illustrating a first process for requesting and receiving a large image file from an application server.

FIG. 3 is a schematic diagram illustrating a second process for requesting and receiving a large image file from an application server.

FIG. 4 is a flowchart of a method for a computing device to request and receive a large image file from an application server.

FIG. 5 is a schematic diagram illustrating an example user interface displaying a first portion of a large image file to a user of a computing device.

FIG. 6 is a schematic diagram illustrating an example user interface displaying a second portion of a large image file to a user of a computing device.

FIG. 7 is a flowchart of a method for obtaining and displaying a stream of images over a specified time window in a user interface of a computing device.

FIG. 8 is a diagram illustrating an example of a computing system which may be used in implementing embodiments of the present disclosure.

### DETAILED DESCRIPTION

Aspects of the present disclosure involve systems, methods, computer program products, and the like, for obtaining and displaying a large image file over a network. In one embodiment, a user utilizes a computing device to obtain a large image file over a network, such as the Internet. The large image file may be stored in and available from a network device, such as an application server or database. To obtain the image file, a user interface executed on the user's computing device determines which portions of the overall image file (referred to herein as “image tiles” of the overall image) are to be displayed in the interface. These image tiles contain subsets of the data stored in the overall image file broken into smaller image tile files, wherein the plurality of image tile files represent all of the data stored in the overall image file. Once the image tiles are determined, the interface may utilize one or more image variables to create or generate one or more network addresses at which the image tiles are stored or otherwise available. In one particular implementation, the variables utilized to generate the network addresses for the image tiles are provided to the user interface prior to requesting the image tiles. Thus, to retrieve the image tiles, the computing device uses the generated network addresses of the identified image tiles to request and obtain the image tiles. The image tiles may then be combined within the user interface and presented to the user of the computing device. By breaking the large image file into smaller image tiles and providing one or more variables to generate the network addresses at which the image tiles may be obtained prior to requesting the tiles, the large image file may be displayed within the user interface faster than previous methods for displaying large image files.

In some implementations of the user interface, various image files may be stacked and viewed as a single image to the viewer. Further, some of the image files may be included in a stream of image files and animated over a time period within the user interface to further provide additional image-related information to a user of the interface. Also, in one implementation, the large image file may include coordinate values associated with image tiles to orient or place the image tiles within the larger image. These coordinates may allow for the viewing and manipulation of any type of large image file, such as high-resolution images of weather-related information, high-resolution images of outer space, high-resolution images of cells or other microscopic entities, and the like. In general, through the systems, methods, and interfaces described herein, accessing, viewing, and manipulating large image files on a user device and available through a network may occur faster and more efficient than current image viewing capabilities.

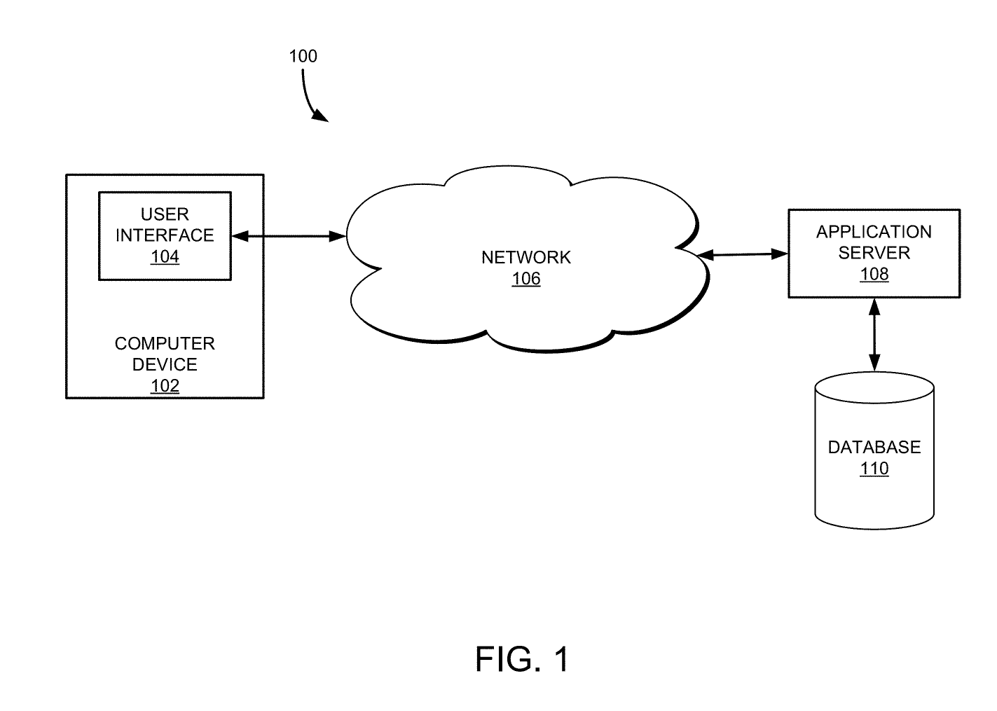

FIG. 1 is a schematic diagram illustrating a system 100 for providing a user interface for viewing and manipulating a large image file available over a network. In general, the system 100 provided may include fewer or more components than are illustrated in FIG. 1. For example, the network 106 may include any number of networking components to facilitate communication between devices connected to the network. As such, the system 100 is provided herein as an example computing system through which large image files available through a network 106 may be accessed, viewed, and/or manipulated through a user interface.

The system 100 includes a computer device 102 to which a user of the system may have access. The computer device 102 may be any type of computing device, including but not limited to, a personal computer such as a desktop or laptop, a tablet device, a mobile phone device, and the like. As described in more detail below, the computer device 102 may include a processor or processors and one or more computer-readable media in which one or more executable instructions or programs are stored. One such program may be a user interface 104 through which a user of the computer device 102 may communicate with a network 106 (which is in communication with the computer device through a network interface) to provide information or data or receive information or data. One such user interface 104 may take the form of a web browser-type program that accesses a public network, such as the Internet, to receive and provide information to a user of the computer device. In general, however, the user interface 104 may be any program executed by the computer device 102 to access one or more components of the network 106.

As mentioned above, the network 106 may be in communication with the computer device 102. The network 106 may include any number of networking devices to facilitate communication between computer devices connected to the network. In one embodiment, the computer device 102 may access an application server 108 or other networking device through the use of the user interface 104. The application server 108 may be programmed or otherwise configured to perform one or more of the operations described herein to provide information to the computer device 102, such as a large image file. In one embodiment, the application server 108 may be in communication with a database 110 that stores at least some of the information available from the network 106. For example, the database 110 may store the large image file available to the computer device 102. In some implementations, the database 110 may be a part of the application server 108 or separate from the server. Further, the database 110 may provide data or files to any number of other devices in communication with the database. Further still, the application server 108 and/or the database 110 may be a part of the network 106 or may be separate from the network. Regardless of the implementation, the system 100 is configured to allow a user utilizing the user interface 104 to request and receive data and/or information from the application server 108 through the network 106.

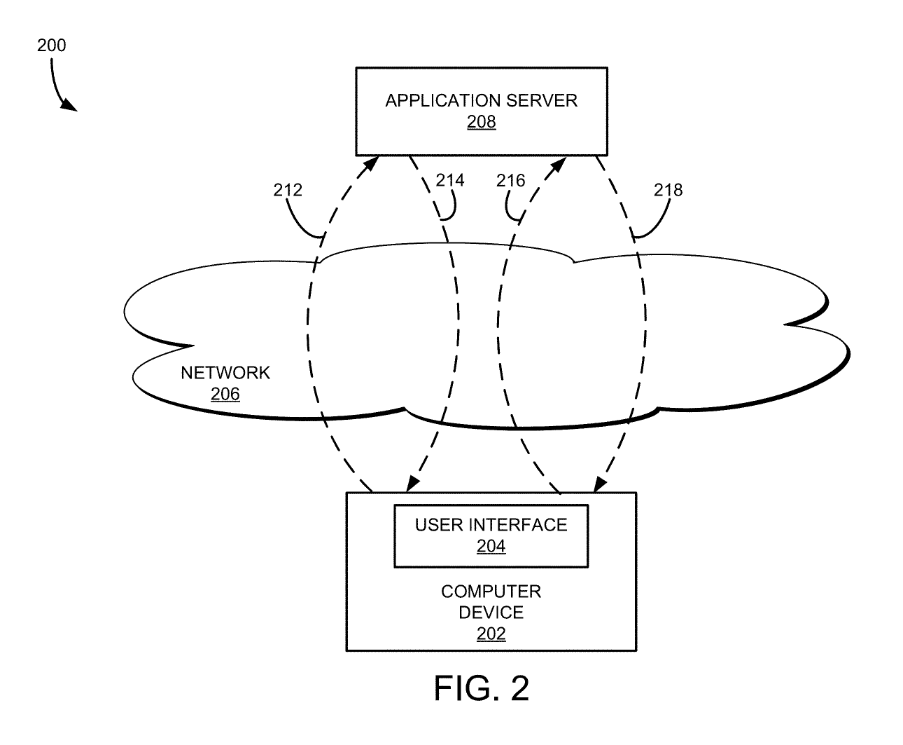

In one particular implementation, the computer device 102 is utilized to access a large image file. Such image files may contain several gigabytes of data or more. Due to the large size of the image file, it may be beneficial in some instances to break the large image file into image tiles and/or store several versions of the large image file and/or image tiles throughout the network to reduce the distance between the computer device 102 and the providing application server 108. FIG. 2 is a schematic diagram illustrating a first process for requesting and receiving a large image file from a network server in circumstances in which the image file is located in various locations within the network 106. The components of the system 200 may be the same or similar to the system 100 described above with relation to FIG. 1. In particular, the system 200 includes a computer device 202 executing a user interface 204 that communicates with an application server 208 over a network 206. The diagram 200 further illustrates the various communicates between the computer device 202 and the application server 208 over the network 206 to request and receive a large image file from the application.

A user of the computer device 202 may utilize the user interface 204 to request an image file from the application server 208, the image file including data that is rendered within the user interface to create an image within the user interface. Initially, the user interface 204 determines which portion of the overall image is requested by the user through the user's interaction with the interface. The user interface 204 than accesses the application server 208 to request (communication 212) a location or address within the network at which the image file for that portion of the overall image is stored. For example, the user interface 204 of the computer device 202 may request a file that includes the destination within the network of the image file or files. In some instances, the location may be a Uniform Resource Locator (URL) or other network location identifier at which the image file is located. In one particular example, the request 212 may include a request for a Keyhole Markup Language (KML) file. The KML file, in general, includes an address or other identifier of the needed image file available from the application server 208 (or potentially from another network device that has the image file stored, such as a database or storage server). In response, the application server 208 returns the file location 214 to the user interface 204.

The user interface 204 may then utilize the returned image file location or identifier to request the image file from the application server 208 (or another networking device through which the image file is available) in communication 216. The application server 208 then returns the requested image file to the computer device 202 in communication 218. In general, the image file may be any type of software image file, such as a .jpeg, .png, .tiff, .bmp, or any other known or hereafter developed image file type. Once received, the user interface 204 may display the image file to the user on the computer device 202. In some instances, the user interface 204 may allow the user to manipulate or alter the image file. However, the process to obtain the image file from the application server 208 includes a first round-trip communication to request and obtain the image file location and a second round-trip communication to request and obtain the image file.

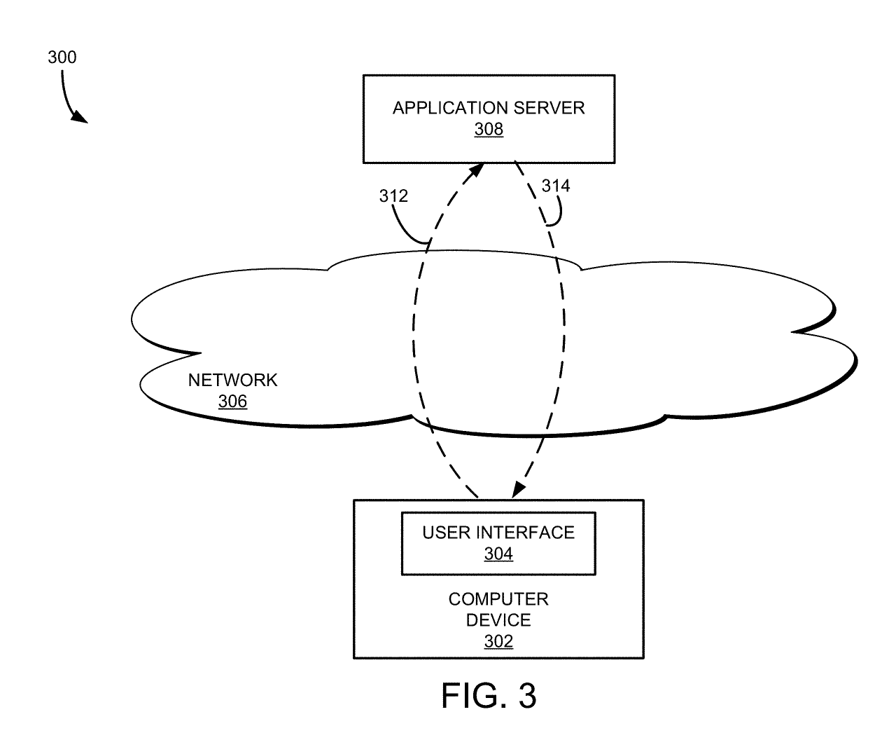

FIG. 3 is a schematic diagram illustrating a second process for requesting and receiving a large image file from a network. The components of the system 300 of FIG. 3 are the same or similar to the components discussed above with relation to FIG. 2. Namely, the system 300 includes a computer device 302 executing a user interface 304 that communicates with an application server 308 over a network 306. Communications between the computer device 302 and the application server 308 are also illustrated. However, in this embodiment, a single round-trip communication between the devices through the network is illustrated, thereby providing a faster retrieval and display of the requested image file.

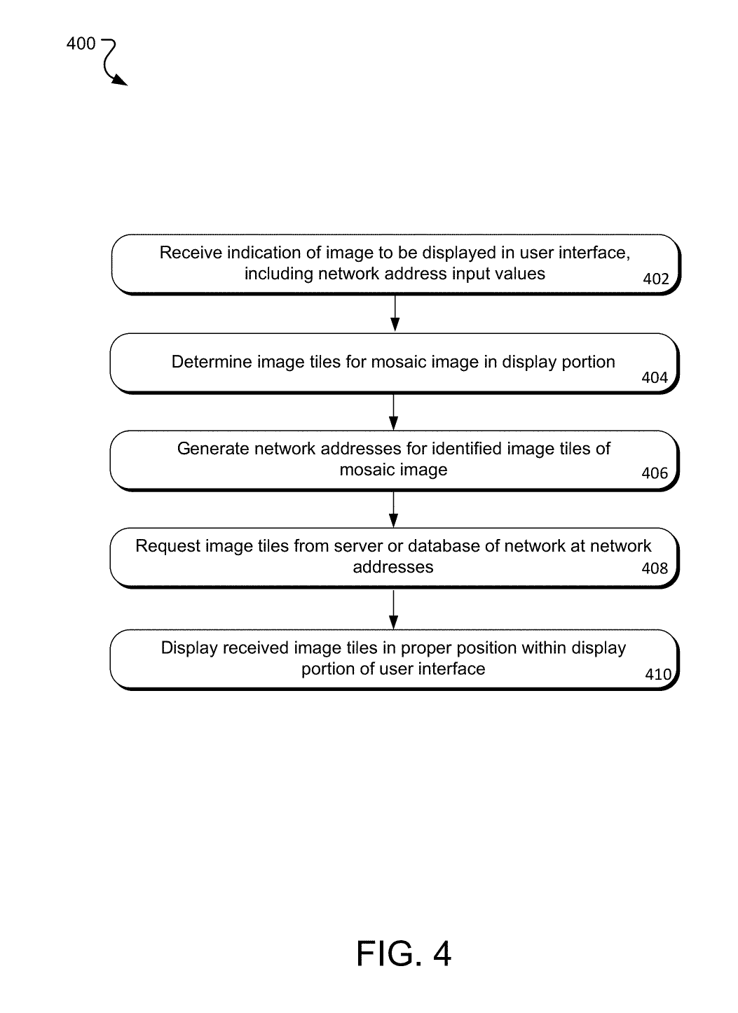

As above, the user interface 304 determines which image file is requested based on an input provided to the user interface from a user of the computer device 302. For example, a user of the interface 304 may select an image to view from a collection of images. In another example, a user may select an image to view that is constructed from more than one image, such as from a collection of image tiles. Once the image file or files are determined by the user interface 304, a request for the image file is transmitted 312 through the network 306 to the application server 308 at a generated URL or other network location identifier. The generation or creation of the network location for the requested image files is discussed in more detail below with relation to the method of FIG. 4. Also similar to above, the application server 308 may return (communication 314) the requested image file to the computer device 302 for display within the user interface 304. However, because the network location of the requested image or images is created by the user interface 304 prior to requesting the image, the file may be received through one round-trip communication between the computer device 302 and the application server 308. In contrast, other procedures to obtain an image file use two round-trip communications to first determine the network location of the image file and then to request the file from the network. As such, the receiving of the image file at the computer device 304 occurs faster and more efficiently than in other embodiments.

Utilizing the system 300 of FIG. 3, the user interface 304 may retrieve and display the large image file from the application server 308 of the network 306. In particular, FIG. 4 is a flowchart of a method 400 for a computer device 302 or a user interface 304 to request and receive a large image file from an application server 308. In general, the operations of the method 400 may be executed or performed by a user interface 304 of a computer device 302. In some instances, the operations of the method 400 may be performed by one or more other programs of portions of the computer device. Through the operations, the user interface 304 may obtain and display an image from an image file faster than previous embodiments of image file requests.

Beginning in operation 402, the user interface 304 receives an indication from the interface or computer device 302 to provide a particular image that has a large amount of data (such as a high-resolution image of several gigabytes of data). More particularly, the user interface 304 is executed on a computer device 302 such that a user of the device may provide inputs to the interface, through such input devices as a mouse, a touch screen, a keyboard, etc. to begin or launch the interface or otherwise select to view an image. In one particular example, the user interface 304 operates within a web browser program of the computer device 302 such that the interface may communicate with a network 306. Thus, the user interface 304 may include one or more HyperText Transfer Protocol (HTTP) requests to download instructions for rendering the interface on a display device of the computer device 302. Further, these instructions may also include network address input values that can be used in the generation of URLs used to retrieve image tile files, as explained in more detail below. In one implementation, the user interface 304 is rendered using HyperText Markup Language (HTML), Cascading Style Sheets (CSS), and/or JavaScript, although any known language for providing an interface to a user of the computer device 302 may be used to create and display the user interface.

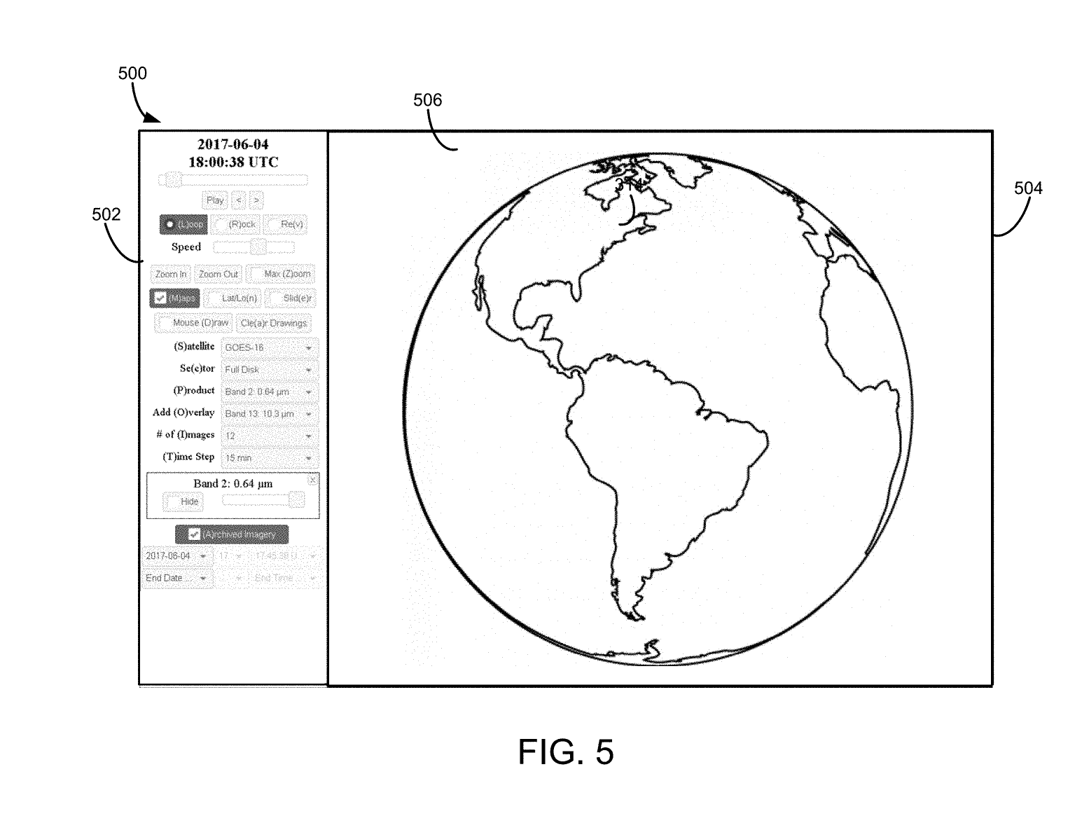

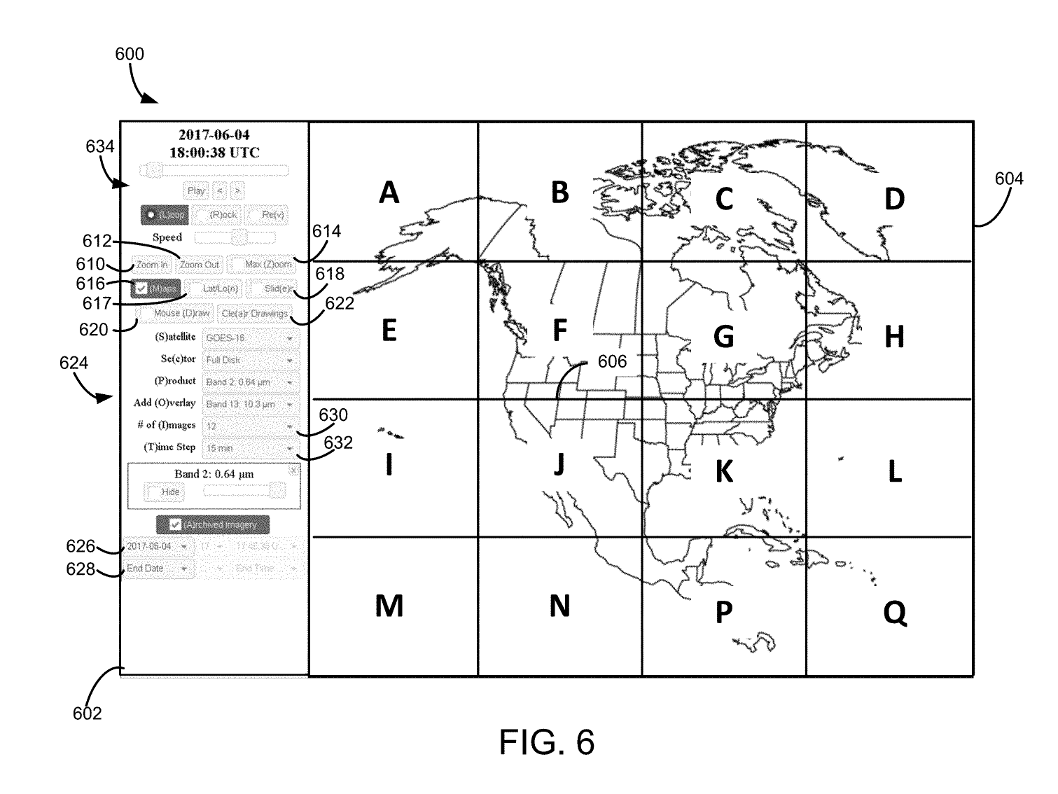

One example of a user interface 500 through which inputs from the user are received is illustrated in FIG. 5. The example user interface 500 is but one possible embodiment of the user interface executed on the computer device discussed above. In general, any user interface for obtaining and viewing an image may be the user interface utilized with the systems and methods described herein. The user interface 500 illustrated includes a control panel portion 502 and an image display portion 504. Additional details of the control panel portion 502 of the user interface 500 are described in more detail below. Turning to the image display portion 504, one or more image files received at the user interface 304 or computer device 302 from the network 306 or the application server 308 may be displayed for a user of the interface, such as on a display device or screen of the computer device 302. In one embodiment, a single image defined by the data in the image file is rendered within the image display portion 504 of the interface 500. In another embodiment, such as that shown in the example user interface 600 of FIG. 6, several images from the data of several image files are displayed simultaneously within the image display portion 604. As should be appreciated, the user interface 500 of FIG. 5 and the user interface 600 of FIG. 6 are similar in appearance. However, the user interface 500 of FIG. 5 illustrates the display of a single image from a single image file while the user interface 600 of FIG. 6 illustrates the display of an image that includes several individual images (image tiles) from individual image files. The individual image tiles are combined to form the overall image shown in the display portion 604. The image display portion 604 of the user interface 600 illustrated in FIG. 6 includes 16 image tiles that are displayed simultaneously to display the overall image, labeled as image tiles A-Q in the Figure. As should be appreciated, the image displayed within the image display portion 604 of the interface 600 may include any number of images tiles to create the displayed image.

In some instances, the user interface 500 may apply a coordinate system to an image such that portions or points within the image (as displayed within the display portion 504 of the interface) are identifiable through a coordinate value. In one embodiment, the coordinates take the form of x-y coordinates, although any coordinate system may be used. For example, if the image of the large image file is a map of a geographic area, the coordinate system may include latitude and longitude coordinates for a portion of the geographic area of the image. Further, the user interface 500 may utilize the coordinate system to determine a relative placement of the various image tiles within the image display portion 504 in operation 404. Turning to the user interface 600 illustrated in FIG. 6, the user interface 600 determines which image tiles A-Q are used to display the image selected by the user of the interface.

Further still, the coordinate system may depend upon a zoom level within an image. For example, the image displayed in the user interface 500 of FIG. 5 may be an example of the image 506 at no zoom level (or a zoom level of zero). At this zoom level of the image, the image 506 may be a single image tile such that the coordinate value associated with the image tile is a default coordinate value, such as an x-coordinate value of zero and a y-coordinate value of zero. At other zoom levels, however, more than one image tile may be utilized to create a mosaic that creates the overall image. For example, a zoom level of one may include four image tiles, while a zoom level of two may include 16 image tiles, such as that shown in the user interface 600 of FIG. 6. It should be appreciated that zoom levels may include any number of image tiles. In addition to including multiple image tiles, the user interface 600 may associate a different coordinate value system to the image tiles. For example, each image tile A-Q of the image in FIG. 6 may have an associated coordinate value that is different from the coordinate value for the other image tiles in the mosaic image. In this manner, the user interface 600 may identify the particular image tiles in the mosaic image based on a coordinate value and zoom level. In some instances, a time-stamp value may also be used to identify a particular image tile. These values, the coordinate value (such as an x-coordinate and a y-coordinate value), a zoom level, and/or a time-stamp value may be utilized to obtain image tiles that are to be included in the mosaic image displayed in the user interface 600.

In one embodiment, the coordinate values and zoom levels may be provided by a user of the user interface 600. For example, once an initial image is displayed in the display portion of the user interface (such as the image of FIG. 5), a user may select to view a zoomed-in version of the image, such as by using the interface to zoom into a portion of the image. To view the zoomed portion of the image, the user may select which portion of the image to view within the user interface 500, such as by clicking on a portion of the image within the display portion 504 or by manipulating buttons or other controls in the control portion 502 of the interface 500. The user interface 500 may then determine a coordinate value associated with the selected portion within the image. For example, each pixel of the high-resolution image may be associated with a particular x-y coordinate value. In another example, a subset of pixels of the image may be associated with an x-y coordinate value. To view a zoomed-in portion of the image, a user may select a point within the image and provide a zoom level value to the user interface. The user interface 500 may then associate a particular coordinate value to the selected point within the image based on the coordinate system applied to the largest version of the high-resolution image. In still further embodiments, the user interface 500 may translate a selected coordinate value at a first zoom level (such as zoom level one) into a corresponding coordinate value at a second zoom level (such as zoom level two). This translation allows the user interface 500 to provide a similar coordinate value between zoom levels within an image.

To create the mosaic image of image tiles, the user interface 600 may utilize CSS to position the image tiles within the interface. In particular, the user interface 600 may utilize CSS to create a “wrapper” box that encompasses the area used by the entire mosaic image at a given zoom level. At some zoom levels, this wrapper may be approximately the size of the display screen of the computer device, while at other zoom levels it may be greater to many times greater in size than the display screen of the computer device. Within the wrapper box, the user interface may orient or place the image tiles based on the coordinate values associated with each image tile of the mosaic image. For example, a mosaic image of four image tiles may place a first image tile in the upper-left corner of the wrapper box based on the first image tile coordinate values. A second image tile may be placed in the upper-right corner of the wrapper box next to the first image tile based on the second image tile coordinate values, and so on. Because each image tile in the mosaic image has a unique coordinate value that indicates the relative position within the wrapper box of the user interface 600, the interface may locate and place each image tile appropriately within the display portion 604 of the interface 600 for viewing by a user of the interface.

With the selected coordinate value in the image and a desired zoom level as inputs or locating values, the user interface 600 determines which image tiles are needed to display the mosaic image in operation 404 of the method 400. In other words, the user interface 600 receives the selected zoom level and coordinate values (or utilizes default coordinate values and zoom levels) and determines which image tiles A-Q are used to create the displayed mosaic image in the display portion 604 of the interface. In one embodiment, the user interface 600 orients the selected coordinate value in the center of the user interface, illustrated as coordinate point 606 in FIG. 6. With the selected coordinate point value and the zoom level, the user interface 600 may then calculate which image tiles are used to populate image tiles A-Q of the display. In one example, each image tile is identified by a row-column value that identifies its location within the mosaic image comprised of all the image tiles for that zoom level combined. For example, image tile A may be calculated to be included in the displayed image and the user interface 600 may identify image tile A from a row-column (or x-y) identifier.

It should be appreciated that the user interface 600 may orient the selected coordinate value of the image in any location within the user interface to determine which image tiles are to be used for the displayed image. For example, the selected coordinate value may be located at the center point 606 of the user interface 600. Thus, the selected coordinate value is a relative value that provides an orienting point to the user interface 600 to determine which image tiles A-Q are used to create the mosaic image selected by a user of the interface. Further, the selected image tiles may also be based on a selected zoom level of the user. In other words, image tiles A-Q of the displayed image may be different at the same coordinate value within the image based on a particular zoom level. For example, viewing the image at a second zoom level would include a first set of image tiles A-Q while viewing a portion of the image at a higher zoom level may include a second set of image tiles A-Q that are different than the first set of image tiles. As such, the determined image tiles to make up the mosaic image may be based on an x-coordinate value, a y-coordinate value, and a zoom level. In other embodiments, other inputs may also be utilized by the user interface 600 to determine the image tiles retrieved to create the displayed image in the display portion 604. In one particular implementation, a timeframe or time window input may be utilized to select particular image tiles, as described in more detail below.

Upon determining which image tiles A-Q are used to provide the mosaic image in the display portion of the user interface 600, the user interface may then determine one or more network addresses or locations within the network for the identified image tiles A-Q in operation 406 of the method 400. In particular, the network address or location for each image tile associated with the mosaic image is generated by the user interface 600 from the image tile identifiers. For example, the user interface 600 may create one or more URL addresses that include an x-coordinate value, a y-coordinate value, a zoom level, and a base image identifier. In some embodiments, the general format of the URL at which the image tiles may be located within the network may be known by the user interface 600 prior to identifying the image tiles used for the mosaic image. Thus, the user interface 600 may simply input the particular image tile identifier values (x, y, zoom level, etc.) into the general URL format to obtain the network address or location from which that particular image tile is available. In this manner, the user interface 600 may create a unique URL for each identified image tile in the mosaic image, with each URL including the particular identifier values for the particular image tile.

In operation 408, the user interface 600 requests the files for the identified image tiles from the network 306. More particularly, the user interface 600 sends a request for the image tile files to an application server 308 or a database 310 available through the network 306. Upon receiving the requested image tile files from the network 306, the user interface 600 may then display the received image tiles in the display portion 604 of the user interface in the orientation determined by the interface to create the requested mosaic image to a viewer of the interface in operation 410. In this manner, images may be displayed and manipulated by a user of the interface 600. Further, because the user interface 600 may generate the network location for the image file or image tile files within the network 306 without requesting the image tile file locations within the network from the server, obtaining and displaying the image occurs faster than interfaces that require two round-trips to the application server 308. This faster retrieval and display provides an improved experience to a user of the interface 600 when interacting with the images.

In addition to displaying the selected images faster than previous image displaying interfaces, the user interface 600 of the present disclosure also provides for options to manipulate a displayed image, control animation of a series of displayed images, zoom into and out of a displayed image, and the like. In particular, the user interface 600 of FIG. 6 includes a control portion 602 that provides various options for a user of the interface to manipulate a displayed image or select to view an available image. It should be appreciated that the control options available through the control panel or portion 602 of the interface 600 are only examples of potential manipulation options available to a user of the interface. More or fewer control options may be provided through the interface 600 to manipulate or select images available through the network 306.

In the control panel 602 illustrated in the user interface 600 of FIG. 6, several buttons, sliders, selectors, windows, and the like are included to provide interactivity with the displayed image. As explained in more detail below, many of the control features allow a user to provide inputs to the user interface 600 to control one or more animations (series of images displayed back-to-back to provide a moving or animated image) displayed within the display portion 604 of the interface. Other control features are provided in the control portion 602 to allow a user of the interface to control or manipulate any image within the display portion. For example, the control panel 602 may include one or more drop down menus 624 to select which image or images from a plurality of available images to display within the display portion 604 of the interface 600. The control portion 602 may also include a control feature (such as a selectable button) to zoom into 610 the image, a control feature to zoom out 612 of the image, and/or a control feature to move directly to the maximum zoom 614 level of the image. Other control features for the displayed image may include a button 616 to toggle a map onto the image, a button 617 to toggle latitude and longitude lines into the image, and/or a button 618 to toggle a slider option within the image to compare two images within the display portion 604. As should be appreciated, the particular control features displayed may be most useful with a type of map image displayed in the display portion 604. Thus, other types of images may include different types of control features in the control portion 602 of the interface 600. In general, the control portion 602 may include any number and types of control features, including different labels and functions associated with the control features included.

In some embodiments of the user interface 600, a user may interact with the displayed image directly in the display portion 604 of the interface. For example, the control portion 602 may include a button 620 or other control feature that allows the user to use an input device to draw within the image. This may provide a collaborative function as the altered image may then be shared with other viewers, such as during a presentation. An erase button 622 may also be included to remove added lines from the image. In another example, a user may utilize the input device to select a portion of the image to zoom into or out of. A selection of a portion to zoom may be performed using a keyboard command, a point and click input from a mouse device, a track wheel input, and the like. Similarly, a user may utilize the input device to drag or otherwise move the image within the display portion 604 to view portions of the overall image. As such, control and manipulation of the displayed image may occur directly in the display portion 604 of the user interface 600.

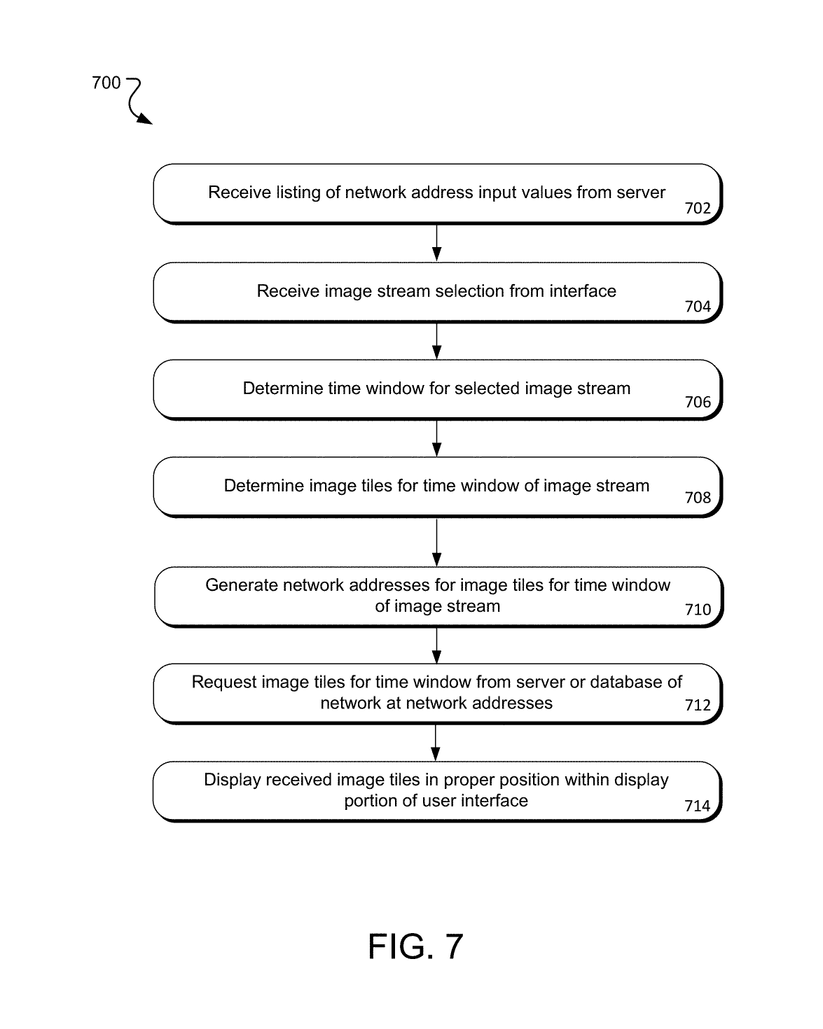

As mentioned above, the image displayed in the display portion 604 of the interface 600 may include a series of images that are displayed in a sequence to create an animated image. FIG. 7 is a flowchart of a method 700 for obtaining and displaying such a collection of images over a specified time window in a user interface 600 of a computing device. Similar to above, the operations of the method 700 may be performed by a user interface configured to display images, such as the user interfaces described herein. Alternatively, one or more of the operations of the method 700 may be performed by other programs or components of a computer device described herein. Through the operations, a user interface may retrieve and display a series of images to create an animated or moving image within the display portion 604 of the user interface 600.

Beginning in operation 702, the user interface 600 receives a listing of time-stamp variables that correspond to available image tiles or other time-sensitive data. For example, the application server 308 may periodically receive updated information, such as from a satellite feed of image data or other periodically updating image source. The images provided from the satellite feed may be time-stamped, such as a value indicating the date and/or the time at which the image was captured. This image data may also be available for viewing through the user interface 600. The application server 308 may thus provide an indicator of one or more time periods corresponding to time-stamped images that are available from the application server. In one particular embodiment, the application server 308 transmits a listing of available images based on the image time-stamps, such as by providing a JavaScript Object Notation (JSON) file to the user interface 600. The listing may include any time-stamp information, such as a listing of dates for which images are available and/or a listing of which times on specific dates images are available. In general, any time-stamp information associated with stored images at the application server 308 (or the database 310) may be provided to the user interface 600. Further, this listing is provided to the user interface 600 prior to the interface determining which time-stamped image tiles may be utilized in a mosaic image in the display portion 604 of the interface.

In operation 704, the user interface 600 receives a selection of an information stream to view. In particular, a user of the interface 600 may select from a group of available image streams to view, such as through drop down menus 624 of the control portion 602 of the interface. In addition, the user interface 600 may determine a time window for the selected image stream that defines a start time and an end time to the animated image stream in operation 706. This time window may be a default time window or may be selected by a user of the user interface 600 through one or more inputs to the interface. For example and utilizing the interface 600 of FIG. 6, the control portion 602 may include several control features to manipulate or select various aspects of the animated set of images. One example of a control feature may include one or more buttons 626 to select a start time (such as a start date or time) and/or an end time 628 (such as an end date or time) that define a time window for the series of images to view. In general, the time window may be any length of time and defined by any time measurement, such as weeks, days, hours, minutes, seconds, etc. Thus, in one embodiment, the selected stream of image data may include a series of images taken over a length of time and time-stamped to indicate when the image was obtained. For example, an image feed from a satellite may be selected to be viewed in the interface 600. As the satellite provides the image data stream, each particular image from the satellite may be time-stamped and stored in a receiving server 308 or database 310 accessible by the user interface 600. The time-stamp associated with each image for the selected image stream may then be utilized by the user interface 600 to determine which images are requested to fit within the time period determined by or provided to the user interface.

In addition to providing a time window for the animated images, a user may also select the number of images to include in the animated series of images and/or time step or interval between subsequent images in the series of time-stamped images. For example, the control portion 602 of the user interface 600 may include a drop-down menu 630 or other control feature to select the number of images to include in a series of animated images from a selected data stream. Similarly, the control portion 602 of the user interface 600 may include a drop-down menu 632 or other control feature to select the time step between images in the image stream. For example, the time step may be set at one hour such that the images selected for display in the interface 600 have time-stamps separated by one hour. Through these controls, the number and types of images included in the animated stream of images may be selected by a user of the interface 600. As should be appreciated, more or fewer such control features may be included in the control portion 602 of the interface 600 to determine which images from the image stream are included in the animated image displayed in the display portion 604.

Returning to the method 700 of FIG. 7, the user interface 600 may use the input received (or may rely on one or more default values) to select the image tiles from the stream of images to include in the animated image in operation 708. In other words, the user interface 600 may determine a coordinate value (such as an x-coordinate value and a y-coordinate value described above), a zoom level (as described above), and a time input to determine which image tiles should be requested for display and animation within the interface 600. Thus, not only are image tiles A-Q determined to create a particular image within the interface, additional image tiles A-Q associated with other time-stamps within the time window are also determined by the user interface to create an animated image within the display portion 604. Once identified, the user interface 600 may generate one or more URLs or other network locations at which the identified image tiles are available in operation 710. Similar to that explained above, the user interface 600 may create one or more URL addresses that include an x-coordinate value, a y-coordinate value, a zoom level, and/or a time-stamp value (among other variable input values) to obtain an image tile for the animated image. The user interface 600 may know which time-stamps have an available image stored in the application server 308 based on the provided listing of available time-stamped images received above. In other words, the user interface 600 may utilize the listing of available time-stamped images received from the application server 308 as described above to obtain one or more variables used to generate the URL at which such images are available. Thus, the user interface 600 may create, for each of the identified image tiles, a unique URL that includes the identifier values (x, y, zoom level, time-stamp, etc.) in the general URL format to obtain the network address or location from which that particular image tile is available.

The user interface 600 may then request the image tiles for the selected time window from the application server 308 of the network 306 in operation 712. In one embodiment, the user interface 600 may utilize the generated network addresses that include the tile identification variables to be obtained by the computer device 302. The use of generated network addresses for the image tiles may improve the speed at which the image tiles are received at the user interface 600. In operation 714, the user interface 600 may display the image tiles sequentially based on the associated time-stamps of the image tiles and in a mosaic structure to provide a coherent image that includes some type of animated image. In this manner, an animated image or portion of an image may be requested and displayed by the user interface 600.

As mentioned above, the user interface 600 may include one or more control features that provide the user with control over an animated portion of the image. For example, the control portion 602 may include a drop-down menu 630 to select the number of images within the time window and/or a drop-down menu 632 to select the time step or interval between images within the time window. Further, the control portion 602 may include other control features 634 for an animated series of images displayed in the display portion 604, such as a play button to begin the animation, one or more time-stamp labels corresponding to the illustrated images, a speed control feature, one or more buttons to define a direction of the animation (i.e., forward or reverse), and the like. In general, any control feature that allows a user of the interface 600 to manipulate or interact with the series of images displayed in the display portion 604 may be provided in the control portion 602 of the interface, including more or fewer control features than are shown in the interface of FIG. 6.

Through the systems and methods described above, a user may utilize a computing device to access a user interface to obtain one or more large image files over a network. To obtain the image file, the user interface determines which image or image tiles are used to create a selected image and accesses a list of network locations at which the image tiles are available from the network. In one particular implementation, the network addresses at which the image tiles are stored are generated by the interface through one or more image tile identification variables prior to requesting the image tiles. The image tiles, upon receipt, may then be combined within the user interface and presented to the user of the computing device through the user interface. By breaking the large image file into smaller image tiles and generating the network address at which the image tiles may be obtained, the large image file may be displayed within the user interface faster than previous methods for displaying large image files. Further, a series of such images or image tiles may be obtained and displayed to provide a moving or animated image to the user, aspects of which may be controlled through one or more control features included in a control portion of the user interface.

In some instances, the network addresses or locations of the image tiles provided to the computer device may be periodically updated to the user interface. For example, the user interface may provide access to a limited time window of image files, such as only providing access to one week's worth of images based on the image time-stamps. Thus, as older images fall outside the supported time window for the user interface (or application server), an updated JSON file or other type of file with input variables used to generate network addresses, such as URLs, for the available image tiles may be provided to the user interface and/or computer device. In another example, more than one application server may provide image data files to requesting devices. Thus, as more application servers become available to provide image files, additional or alternate network addresses corresponding to the newly available servers may be provided to the user interface or computer device. Utilizing various application servers to provide the image files may also allow the user interface to load balance between the various application servers such that one or more of the servers do not become overloaded with requests for image files.

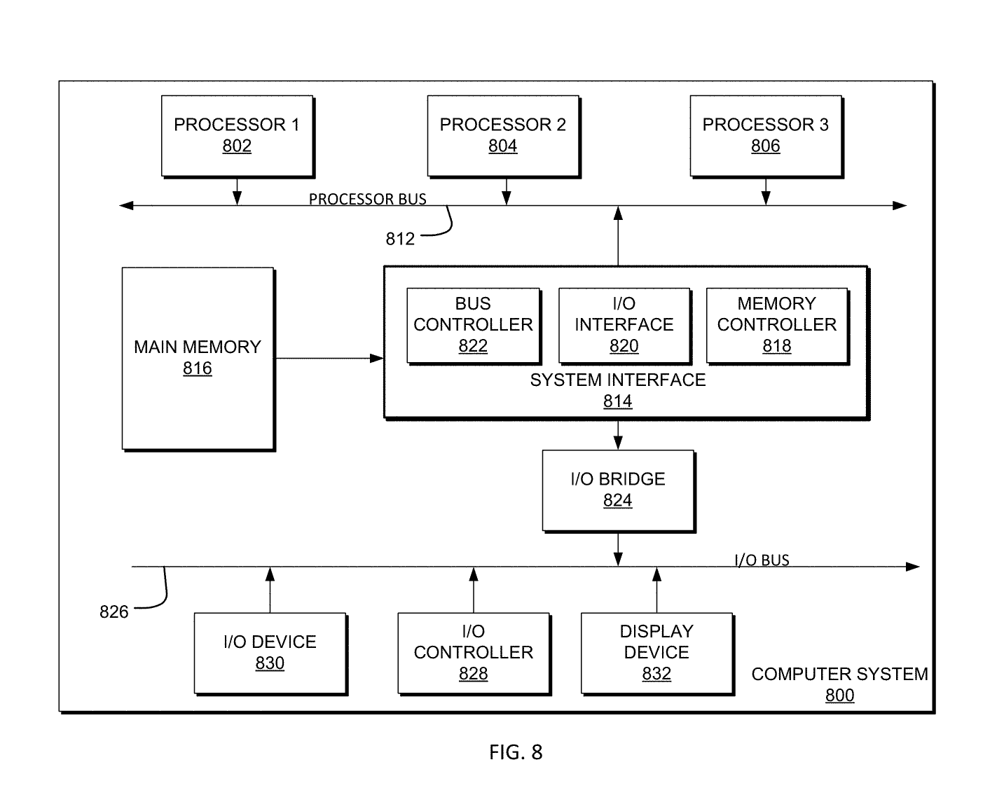

FIG. 8 is a block diagram illustrating an example of a computing device or computer system 800 which may be used in implementing the embodiments of the components of the network disclosed above. For example, the computing system 800 of FIG. 8 may be the computer device 302 or the application server 308 of the systems discussed above. The computing system (system) includes one or more processors 802-806. Processors 802-806 may include one or more internal levels of cache (not shown) and a bus controller 822 or bus interface unit to direct interaction with the processor bus 812. Processor bus 812, also known as the host bus or the front side bus, may be used to couple the processors 802-806 with the system interface 814. System interface 814 may be connected to the processor bus 812 to interface other components of the system 800 with the processor bus 812. For example, system interface 814 may include a memory controller 818 for interfacing a main memory 816 with the processor bus 812. The main memory 816 typically includes one or more memory cards and a control circuit (not shown). System interface 814 may also include an input/output (I/O) interface 820 to interface one or more I/O bridges or I/O devices with the processor bus 812 through an I/O bridge 824. One or more I/O controllers and/or I/O devices may be connected with the I/O bus 826, such as I/O controller 828 and I/O device 830, as illustrated.

I/O device 830 may also include an input device (not shown), such as an alphanumeric input device, including alphanumeric and other keys for communicating information and/or command selections to the processors 802-806. Another type of user input device includes cursor control, such as a mouse, a trackball, or cursor direction keys for communicating direction information and command selections to the processors 802-806 and for controlling cursor movement on a display device 832 associated with the computing device.

System 800 may include a dynamic storage device, referred to as main memory 816, or a random access memory (RAM) or other computer-readable devices coupled to the processor bus 812 for storing information and instructions to be executed by the processors 802-806. Main memory 816 also may be used for storing temporary variables or other intermediate information during execution of instructions by the processors 802-806. System 800 may include a read only memory (ROM) and/or other static storage device coupled to the processor bus 812 for storing static information and instructions for the processors 802-806. The system set forth in FIG. 8 is but one possible example of a computer system that may be employed or configured in accordance with aspects of the present disclosure.

According to one embodiment, the above techniques may be performed by computer system 800 in response to processors 802-806 executing one or more sequences of one or more instructions contained in main memory 816. These instructions may be read into main memory 816 from another machine-readable medium, such as a storage device. Execution of the sequences of instructions contained in main memory 816 may cause processors 802-806 to perform the processing steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 816. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

1. A computer system for operating a network, the system comprising:
a network device storing a plurality of image data files in communication with a communications network, the plurality of image data files corresponding to a particular source of related image files that form at least one image; and
a computing device in communication with the network device over the communications network, the computing device comprising:
a processing device; and
a computer-readable medium connected to the processing device configured to store instructions that, when executed by the processing device, perform the operations of:
receiving a selection of the particular source of related image files from an input of an input device of the computing device;
identifying a subset of the plurality of image data files corresponding to the particular source of related image files, the subset of the plurality of image data files corresponding to a portion of the at least one image;
generating, at the computing device, a network address for each of the subset of the plurality of image data files, wherein generating a network address for an image data file of the subset of the plurality of image data files comprises inserting one or more respective identification variables unique to the image data file into a general format address;
transmitting each of the network addresses for the subset of the plurality of image data files to the network device to request the subset of the plurality of image data files;
receiving the subset of the plurality of image data files; and
processing the subset of the plurality of image data files to display the at least one image on a display device of the computing device.

2. The computer system of claim 1 wherein each of the network addresses for the subset of the plurality of image data files comprises a Uniform Resource Locator (URL) address associated with the network device.

3. The computer system of claim 1 wherein the one or more respective identification variables comprise at least a coordinate value associated with a placement within the at least one image for the image data file.

4. The computer system of claim 1 wherein the one or more respective identification variables comprise at least a zoom level value associated with the corresponding image data file.

5. The computer system of claim 1 wherein the network device is an application server in which the plurality of image data files corresponding to the particular source of related image files that form the at least one image is stored.

6. The computer system of claim 1 wherein the instructions further cause the processing device to perform the operation of:
receiving a listing of a time-stamp information associated with the subset of the plurality of image data files, the time-stamp information indicating a particular date and time that at least one of the subset of the plurality of image data files was obtained, wherein the plurality of identification variables unique to the corresponding image data file of the plurality of image data files comprise at least a time-stamp value included in the time-stamp information.

7. The computer system of claim 6 wherein each of the subset of the plurality of image data files comprise a time-stamp value associated with a position in a sequence of time-stamped images.

8. The computer system of claim 7 wherein the instructions further cause the processing device to perform the operation of:
receiving an indication of a time window received from the input device of the computing device.

9. The computer system of claim 8 wherein the subset of the plurality of image data files are displayed on the display device in the sequence of time-stamped images to create an animated image.

10. A method for providing a file from a network device, the method comprising:
storing a plurality of image data files in a storage media associated with the network device comprising a portion of a communications network, the plurality of image data files corresponding to a particular source of related image files that form at least one image and each of the plurality of image data files associated with a plurality of identification variables unique to a corresponding image data file of the plurality of image data files;
receiving, from a computer device in communication with the communications network, a request for a subset of the plurality of image data files from the computer device utilizing a plurality of network addresses, each of the network addresses for the subset of the plurality of image data files comprising the plurality of identification variables unique to the corresponding image data file of the subset of the plurality of image data files and generated by the computer device by inserting the plurality of identification variables unique to the corresponding image data file into a general format address, wherein each of the subset of the plurality of image data files corresponds to a portion of the at least one image; and
providing the subset of the plurality of image data files to the computer device through the communications network for display on a display device associated with the computer device based at least on the received request for the subset of the plurality of image data files from the computer device.

11. The method of claim 10 wherein each of the network addresses for the subset of the plurality of image data files comprises a Uniform Resource Locator (URL) address associated with the network device.

12. The method of claim 10 further comprising:
transmitting a listing of time-stamp information associated with the subset of the plurality of image data files, the time-stamp information indicating a particular date and time that at least one of the subset of the plurality of image data files was obtained, wherein the plurality of identification variables unique to the corresponding image data file of the plurality of image data files comprise at least a time-stamp value included in the time-stamp information.

13. The method of claim 12 wherein the listing of the time-stamp information associated with the subset of the plurality of image data files transmitted through the communications network comprises a JavaScript Object Notation (JSON) file.

14. The method of claim 13 wherein each of the subset of the plurality of image data files comprise a time-stamp value associated with a position in a sequence of time-stamped images.

15. The method of claim 14 wherein the time-stamp of each of the subset of the plurality of image data files corresponds to a time window received from the computer device.

16. The method of claim 15 wherein the subset of the plurality of image data files are displayed on the display device associated with the computer device in the sequence of time-stamped images to create an animated image.

17. The method of claim 10 wherein storing the plurality of image data files comprises storing the plurality of image data files to an application server.

18. The method of claim 10 wherein the plurality of identification variables unique to a corresponding image data file of the plurality of image data files comprise at least a coordinate value associated with a placement within the at least one image for the corresponding image data file.

19. The method of claim 10 wherein the plurality of identification variables unique to the corresponding image data file of the plurality of image data files comprise at least a zoom level value associated with the corresponding image data file.

20. The method of claim 10 further comprising:
providing one or more instructions to the computer device for execution by the computer device, the instructions creating a user interface on the display device through which the at least one image is displayed.
